(19) United States
(12) Patent Application Publication
(10) Pub. No.: US 2015/0081575 A1
(43) Pub. Date: Mar. 19, 2015

(54) PROFESSIONAL NETWORKING SYSTEM AND METHODS

(71) Applicant: MARLYTICS, LLC, TUCSON, AZ (US)

(72) Inventors: Daniel M. Jaffe, Tucson, AZ (US); Derek M. Johnson, Bradenton, FL (US)

(21) Appl. No.: 14/487,614

(22) Filed: Sep. 16, 2014

Related U.S. Application Data
(60) Provisional application No. 61/878,600, filed on Sep. 16, 2013.

(51) Int. Cl. G06Q 50/00; G06Q 50/18; H04L 12/18

(52) U.S. Cl. CPC G06Q 50/01; H04L 12/1813; G06Q 50/18
USPC 705/319

(57) ABSTRACT

A professional networking system is provided. The system includes a plurality of member websites, each being associated with a member of the professional networking system, and each having a unique domain name. The system further includes a professional networking application that is hosted at least partially on a server and electronically accessible over at least one network system to at least one member computer device. The professional networking application is configured to provide members controlling access to their respective associated websites of the plurality of member websites. A member recommendation module is further included that is configured to receive from a member a recommendation for another member and to facilitate display of the recommendation on a website associated with the recommended member.

### CROSS REFERENCE TO RELATED APPLICATION

This application is a non-provisional application gaining priority from provisional patent application Ser. No. 61/878,600, filed Sep. 16, 2013, the contents of which are incorporated herein in their entirety.

### FIELD OF THE DISCLOSURE

The present disclosure is generally related to web-based social networks, and more particularly is related to professional networking systems and methods including a plurality of member websites.

### BACKGROUND OF THE DISCLOSURE

In practice, professionals in many fields, such as lawyers, doctors, bankers and the like, often rely on informal and inefficient word-of-mouth networks to generate business and new sources of revenue (e.g., by attracting and keeping new clients). For example, lawyer-to-lawyer referrals can be a significant source of new business. Another source of new business often comes through having an effective web presence, e.g., optimized websites, blogs and the like which can increase the likelihood that potential new clients will find and contact the lawyer when in need of legal services.

Many social media networks, such as Facebook, Twitter and others are well-known and commonly used. However, such networks are typically used for entertainment or social purposes, as opposed to professional use. While some companies may utilize their Facebook “page” as their primary website, most prefer to have a more professional and customizable site to serve as the face of their business online. Other networks, such as LinkedIn, are directed more specifically to professionals. However, such networks are aimed primarily for use by individuals (e.g., as a means to connect with other professional individuals) and cannot effectively serve as a professional entity's primary website. Further, while existing social and/or professional network systems provide various features for connecting with other users, a significant drawback of such networks, at least with respect to their use as a significant or primary website by professional entities, is that the networks (including the content) are typically owned and controlled by the company operating the network (i.e., Facebook, LinkedIn, etc.). Thus, users having a “page” in such networks don't really have anything of their own, or that they can control. Instead, users are in essence loaned space on the network's (i.e., the company operating the network's) domain (e.g., facebook.com/username).

However, building a professional website typically requires considerable expertise and/or expenditure of cash. As such, many professional entities (particularly, but not exclusively, smaller firms) feel they have little option in terms of promoting their business online but to utilize such existing networks as their primary web presence, or have none at all.

Thus, a heretofore unaddressed need exists in the industry to address the aforementioned deficiencies and inadequacies.

### SUMMARY OF THE DISCLOSURE

Embodiments of the present disclosure provide a professional networking system. Briefly described, in architecture, one embodiment of the system, among others, can be implemented as follows. A professional networking system includes a plurality of member websites, each being associated with a member of the professional networking system, and each having a unique domain name. A professional networking application is included and is hosted at least partially on a server and electronically accessible over at least one network system to at least one member computer device. The professional networking application is configured to provide members controlling access to their respective associated websites of the plurality of member websites. A member recommendation module is included and is accessible to members through the professional networking application. The member recommendation module is configured to receive from a first member a recommendation for a second member and to facilitate display of the recommendation on a website of the plurality of member websites associated with the second member.

In another embodiment, a computer-implemented professional networking process is provided that includes: providing a professional networking application, hosted at least partially on a server and electronically accessible over at least one network system to at least one member computer device, the professional networking application being configured to access a plurality of member websites, each being associated with a member of the professional network, the plurality of member websites each having a unique domain name; providing members controlling access to their respective associated websites of the plurality of member websites; receiving, by a member recommendation module accessible to members through the professional networking application, from a first member a recommendation for a second member; and displaying the recommendation on a website of the plurality of member websites associated with the second member.

In yet another embodiment, a non-transitory computer readable medium containing instructions for providing a professional networking process enabled at least in part on a processor of a computerized device is provided, wherein a plurality of member websites is electronically accessible by the processor, each of the member websites being associated with a member of the professional networking system and each having a unique domain name, and a professional networking application is hosted at least partially on a server and electronically accessible over at least one network system to at least one member computer device, the instructions, which when executed by the processor, performing the steps of: providing members controlling access to their respective associated websites of the plurality of member websites; receiving, by a member recommendation module accessible to members through the professional networking application, from a first member a recommendation for a second member; and displaying the recommendation on a website of the plurality of member websites associated with the second member.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of a professional networking system, in accordance with a first exemplary embodiment of the present disclosure.

FIG. 2 is an illustration of a webpage provided by the professional networking application of FIG. 1, in accordance with the first exemplary embodiment of the present disclosure.

FIG. 3 is an illustration of webpage provided by the professional networking application of FIG. 1, in accordance with the first exemplary embodiment of the present disclosure.

FIG. 4 is an illustration of webpage provided by the professional networking application of FIG. 1, in accordance with the first exemplary embodiment of the present disclosure.

FIG. 5 is an illustration of webpage provided by the professional networking application of FIG. 1, in accordance with the first exemplary embodiment of the present disclosure.

FIG. 6 is an illustration of webpage provided by the professional networking application of FIG. 1, in accordance with the first exemplary embodiment of the present disclosure.

FIG. 7 is an illustration of webpage provided by the professional networking application of FIG. 1, in accordance with the first exemplary embodiment of the present disclosure.

FIG. 8 is an illustration of webpage provided by the professional networking application of FIG. 1, in accordance with the first exemplary embodiment of the present disclosure.

FIG. 9 is an illustration of webpage provided by the professional networking application of FIG. 1, in accordance with the first exemplary embodiment of the present disclosure.

FIG. 10 is an illustration of a member webpage which the member may access and control using the system of FIG. 1, in accordance with the first exemplary embodiment of the present disclosure.

FIG. 11 is an illustration of a member webpage which the member may access and control using the system of FIG. 1, in accordance with the first exemplary embodiment of the present disclosure.

FIG. 12 is a flowchart illustrating a computer-implemented professional networking process in accordance with an embodiment of the disclosure.

### DETAILED DESCRIPTION

Many embodiments of the disclosure may take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

The disclosure also can be practiced in distributed computing environments, where tasks or modules are performed by remote processing devices that are linked through a communications network. Moreover, the disclosure can be practiced in Internet-based or cloud computing environments, where shared resources, software and information may be provided to computers and other devices on demand. In a distributed computing environment, program modules or subroutines may be located in both local and remote memory storage devices. Aspects of the disclosure described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks including the cloud. Data structures and transmissions of data particular to aspects of the disclosure are also encompassed within the scope of the disclosure.

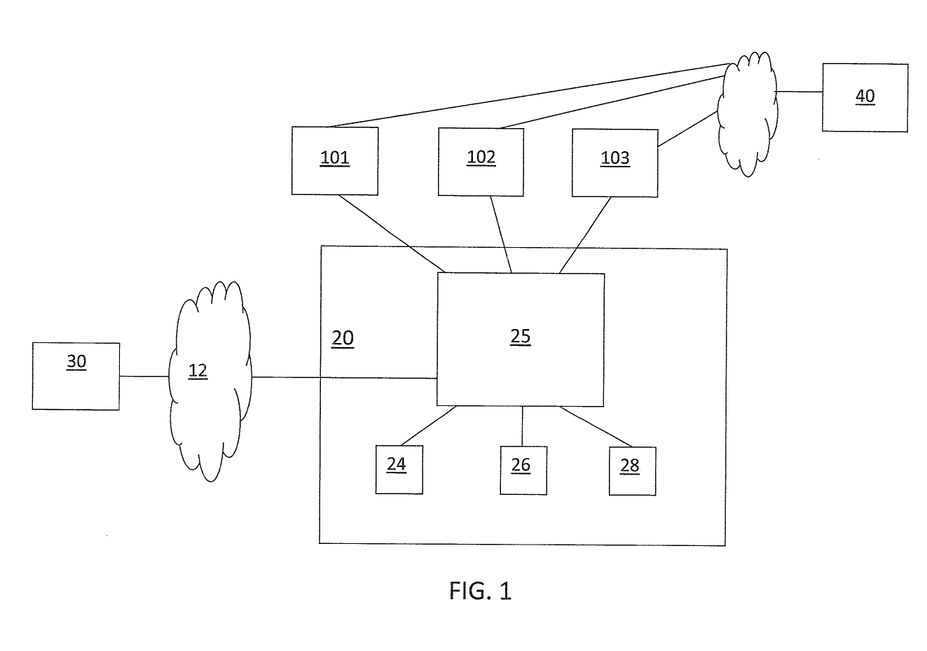

FIG. 1 is a schematic illustration of a professional networking system 10, in accordance with a first exemplary embodiment of the present disclosure. The professional networking system 10, which may also be referred to as ‘system 10’, includes a professional networking application 25, electronically accessible over at least one network system 12 and hosted at least partially on a server 20. At least one member device 30 is positioned to access the professional networking application 25.

The server 20 may be or include any database capable of storing and/or providing access to information, such as an electronic database, a computer and/or computerized server, database server or generally any network host capable of storing data and connected to any type of data network. Further, the server 20 may include or be a part of a distributed network or cloud computing environment. Any type of electronic and/or computerized device that is capable of storing information may be included as the server 20, and is considered within the scope of this disclosure. The server 20 may include computer-readable storage media, and a processor for processing data and executing algorithms, including any of the processes and algorithms set forth in this disclosure. The professional networking application 25 is electronically accessible over at least one network system 12. The network system 12 may include any type of network infrastructure, such as the Internet, or any other wired, wireless and/or partially wired network. The server 20, application 25 and network system 12 may include a variety of hardware and software components to provide successful functioning of the server 20 and the application 25, as is well-known within the art. Further, any features, characteristics, designs and/or functions that are known within the art may be included with the system 10 to further enhance its efficiency.

The member device 30 may be any device that is capable of communicating with the application 25, for example via a network system 12, and may be operated by any member of the professional networking service, or any representative thereof. Any number of member devices 30 may use the system 10 at any given time. The member device 30 may access the application 25 through a variety of ways, including through a computerized device in communication with the system 10 over a network system. For example, the member device 30 may be any computer, including any personal computer, Internet appliance, hand-held device (including palm-top computers, wearable computers, cellular or mobile phones, multi-processor systems, processor-based or programmable consumer electronics, network computers, minicomputers) and the like. One or more input devices, such as a keyboard, mouse, camera, microphone and the like, may be used to transmit information to and/or request information from the application 25 by the member device 30.

The professional networking application 25 may be fully or partially hosted on the server 20. The professional networking application 25 may include any tool, device, system, process or combination thereof, which assists or makes possible a centralized network interface for creating, editing or maintaining member websites, as well as searching other members of the professional network, recommending other members and providing that recommendation to the recommended member's website (which may first require approval by the recommended member), or commenting on other members' blogs or other posts through the system 10 and providing the comment to the website of the member's blog, as will be described in further detail below. The application 25 may include any computer-readable memory or databases, which may be stored in any computer-readable medium, and may be accessible by a computer processor. The application 25 may further include or access computer program instructions which may cause a processor to perform any algorithms and/or functions which may be described in this disclosure.

The system 10 includes a plurality of member websites 101-103, each associated with a unique domain name (e.g., ABCLaw.com; JohnDoeLawFirm.com; bankruptcylawyer.com) and controlled (i.e., creation, editing, maintenance of the website) by a member of the professional networking system 10. As is known in the relevant field, a website is a set of related web pages served from a single web domain. Some members may have multiple unique domain names (and associated websites) in the system 10; however, each member has a website having at least one unique domain name. The member websites 101-103 may be publicly accessible over the Internet. That is, a user of any Internet-accessible computer device (e.g., public user device 40) may access and view the member websites 101-103, without requiring access to the professional networking application 25.

The system 10 further includes a website management module 24. The application 25 has access to the website management module 24, which may be fully or partially hosted on the server 20, or may be hosted elsewhere and otherwise accessible to the application 25. The website management module 24 provides tools for facilitating member website creation, editing and maintenance. The website management module 24 may access or include databases for storing website-related data such as, for example, website templates, member website content (including, for example, text, image, video or other such member-created content) which a member may upload for use on the member's website, and the like.

The member websites may be created, edited, updated, etc. by inputting information by a member utilizing a member device 30. The websites may be created, for example by inputting requested information to the system 10 upon registering as a member of the professional network service provided by system 10.

A blog management module 26 is also included in the system 10. The professional networking application 25 has access to the blog management module 26, which may be fully or partially hosted on the server 20, or may be hosted elsewhere and otherwise accessible to the application 25. The blog management module 26 provides tools for facilitating member blog posts, as well as commenting on member blogs through the system 10. The blog management module 26 may access or include databases for storing blog-related data such as, for example, member-created blog content (e.g., current and/or archived blog posts). Member blogs may be embedded in the member websites 101-103, with blog entries being created through accessing the blog management module 26 via the application 25. Alternatively or additionally, member blogs may be hosted on a separate website, with the application 25 and blog management module 26 having sufficient access to push blog entries created by the member via the application 25 to the separate blog site.

The blog management module 26 allows a member to apply access-restrictions for commenting on the member's blog post. For example, a member may create a new blog post, publish the blog posting to the member's blog (which may be embedded in that member's website), and further, the member may specify whether others may comment on the blog post, and if so, whether only other members may comment or whether any viewer (i.e., non-member public viewers) of the blog may post comments.

The system 10 further includes a member recommendation module 28. The professional networking application 25 has access to the recommendation module 28, which may be fully or partially hosted on the server 20, or may be hosted elsewhere and otherwise accessible to the application 25. The recommendation module 28 provides tools for facilitating member-to-member and public (i.e., non-member)-to-member recommendations through the system 10. The recommendation module 28 may access or include databases for storing recommendation-related data such as, for example, received recommendations for a member, as well as any recommendations the member may have made for other members. Recommendations received through the system 10 may be available for display on the member websites 101-103, with new member-to-member recommendations being created by accessing the recommendation module 28, with respect to a particular member's profile (or other website-identifying information) via the application 25 and then providing a recommendation for that member. Recommendations received from non-members (e.g., via email, a mailed letter, etc.) may be manually entered by the recommendation receiving member through the application, and thus becomes available for the member to display on her member website. The recommendation module 28 includes functionality to allow a member to require her approval before posting a received recommendation on the member's website. Further, the recommendation module 28 allows members to request other members and/or non-members to provide a recommendation through the system 10. For example, a member may utilize the recommendation module 28 to send a recommendation request to another member which may be filled out and directly entered into the application 25, and displayed on the recommendation-receiving member's website (which may first be subject to the member's approval).

The application 25 may include or provide access to a web or network-based software platform, including a graphical user interface or webpage which provide interactive access to the system 10 to members of the professional network through a member device 30.

In practice, legal (and other) professionals often rely on informal networks to generate revenue (e.g., by attracting and keeping new clients). For example, lawyer-to-lawyer referrals can be a significant source of new business. Another source of new business often comes through having a web presence, e.g., optimized websites, blogs and the like which increases the likelihood that potential new clients will find and contact the lawyer when in need of legal services. The professional networking system 10 accomplishes both of these objectives by allowing members (e.g., lawyers) to build a reputation amongst other members (and thus, build a referral network), and further streamlines and simplifies the process of creating and managing an optimized external (i.e., as seen by the public) website. Using the system 10, a member uses a member device 30 to access the professional networking application 25. The professional networking application 25 may be a web-based application and may require authorization information, such as username and password, before allowing the member to access the application 25.

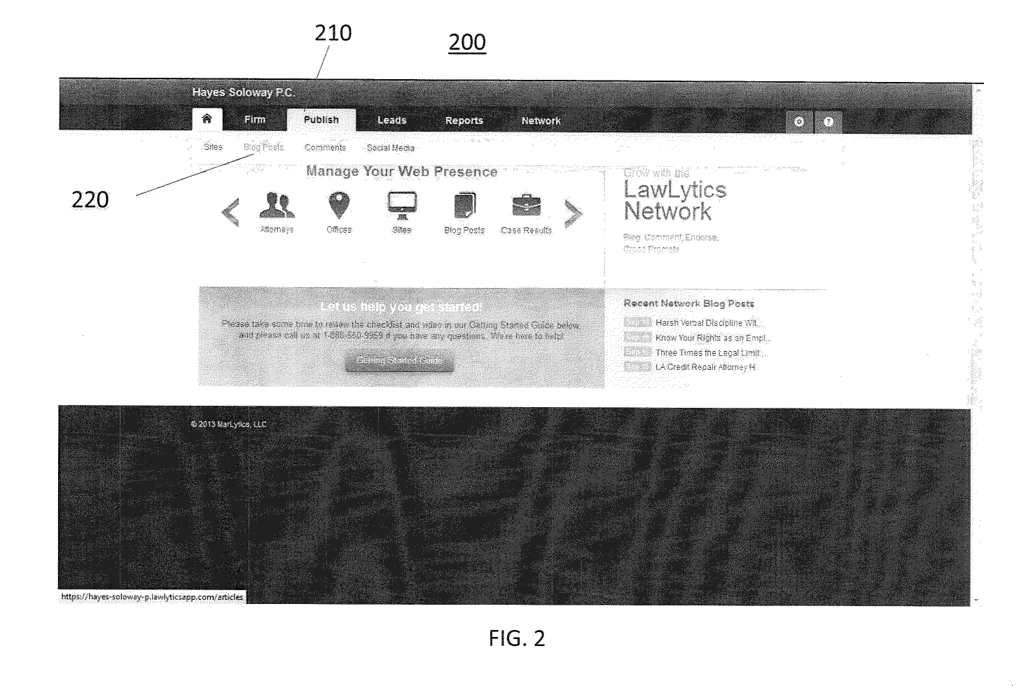

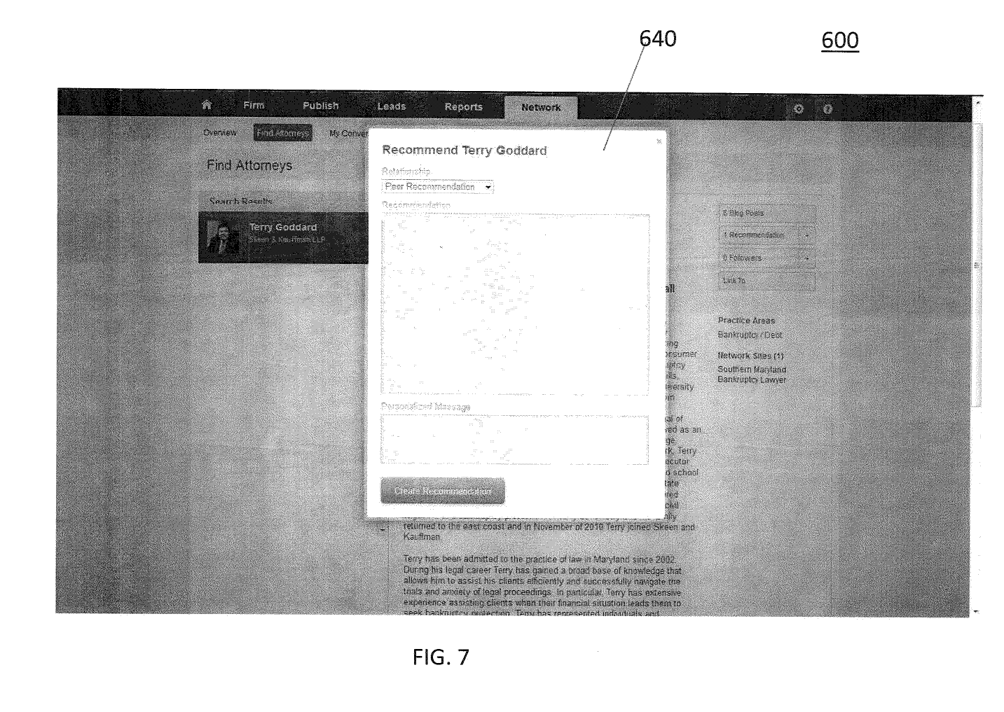

FIGS. 2-9 illustrate features of the system 10 as seen through various views, or web pages, provided to members accessing the professional networking application 25 of the system 10. FIG. 2 illustrates a webpage 200 which may be the “dashboard” or the interface provided by the application 25 to a member after successfully logging into the application 25. The webpage 200 may display a variety of selectable options for managing a member's websites, blog posts, comments, leads, reports and so on.

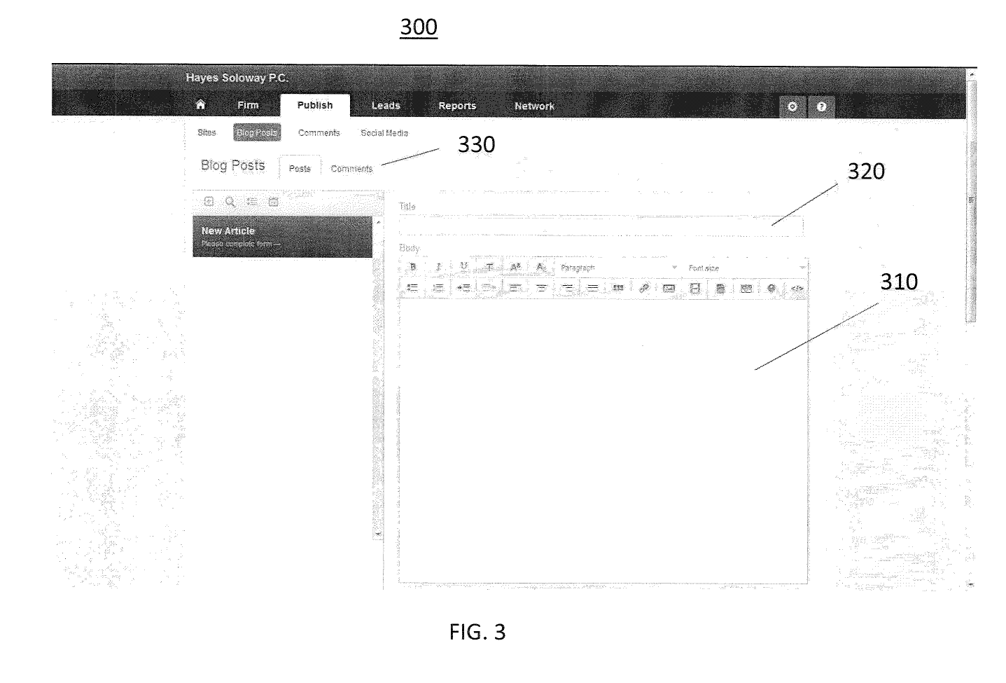

Selecting the “publish” tab 210 and then selecting “blog posts” 220 will take the member to the “blog posts” webpage 300 shown in FIG. 3. The application 25 provides and displays the blog posts page 300 to a member, for example, by accessing the blog management module 26. The member may create a new blog entry by inputting text in a field 310 provided on the blog posts page 300. A title field 320 may be included for entering a title for the blog post. The member may then publish the blog post (i.e., push the newly created blog posting to an embedded blog feature on the member's website), where it may be available to any Internet user. The blog posts page 300 may further include a selectable menu for specifying where to publish the blog post (e.g., by choosing a particular website, in the case where the member has multiple websites through the system 10), and further may include a menu for specifying who (i.e., members or non-members), if any, may provide comments to the newly created blog post. A “comments” tab 330 allows the member to review any comments which others have provided to the member's blog posts. The member may require that all comments first be approved by the member before allowing comments to be displayed on the member's website and/or displayed to other members within the application 25.

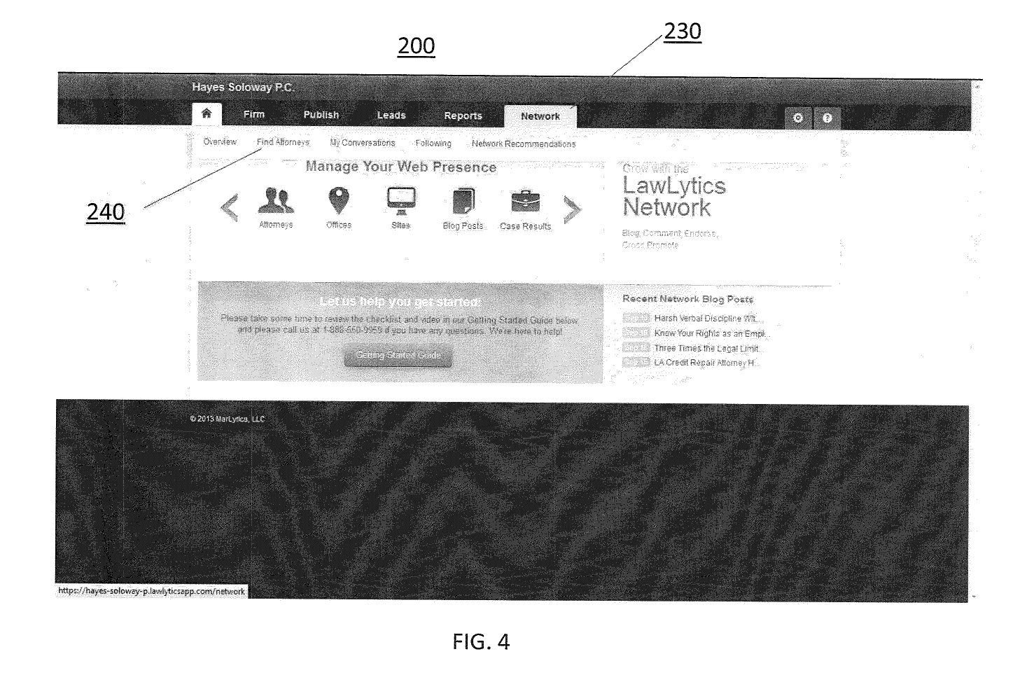

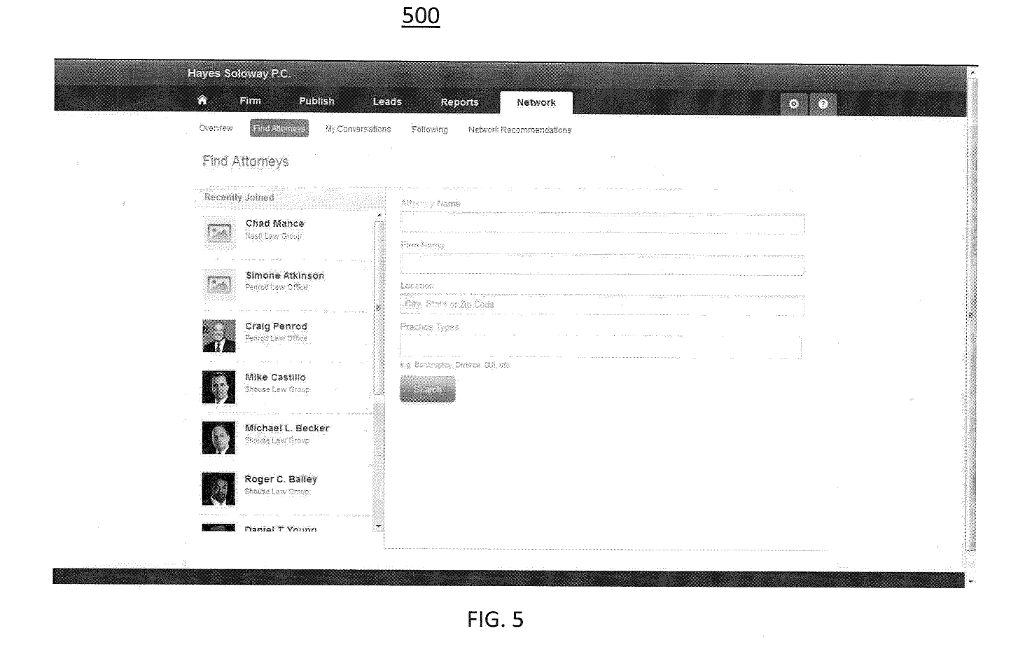

FIG. 4 again illustrates the dashboard page 200 of FIG. 2, but shows the submenu displayed when the “network” tab 230 is selected. When “find attorneys” is selected, the application 25 provides the member with the “Find Attorneys” page 500 shown in FIG. 5. The “Find Attorneys” page 500 allows a member to search other attorney members of the networking system 10, by name, practice type, location and the like.

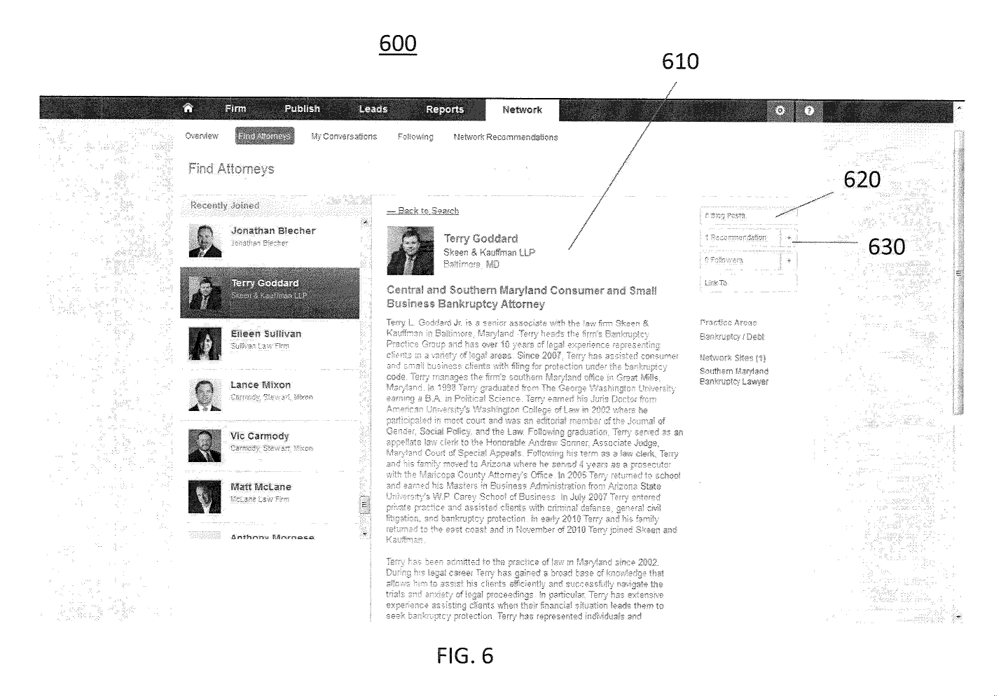

As shown in the page 600 of FIG. 6, when a particular attorney member in the “Find Attorneys” page is highlighted, profile information 610 (which may be user-provided, and may be pulled directly from the member's website content) for the highlighted attorney member is displayed. Further, a blog post tab 620 and a recommendation tab 630 are displayed for that attorney member. Selecting the blog post tab 620 will provide an inquiring member with the selected attorney member's blog posts made through the system 10, and may further allow the inquiring member to comment on the blog posts. A new recommendation may be provided for the attorney member by selecting the “+” on the recommendation tab 630, causing the application 25 to provide a recommendation window 640, allowing the inquiring member to directly input a recommendation message for the selected attorney member, as well as a personalized message which will only be viewable by the selected attorney member. Further, the inquiring member may select a relationship (e.g., peer member, client, etc.) with the selected attorney. Once provided, the recommendation message may be made available to the selected (i.e., the recommended) attorney member, who may require such recommendation messages to be approved by him before they will be provided for display on his own website and/or associated with his profile information in the application 25.

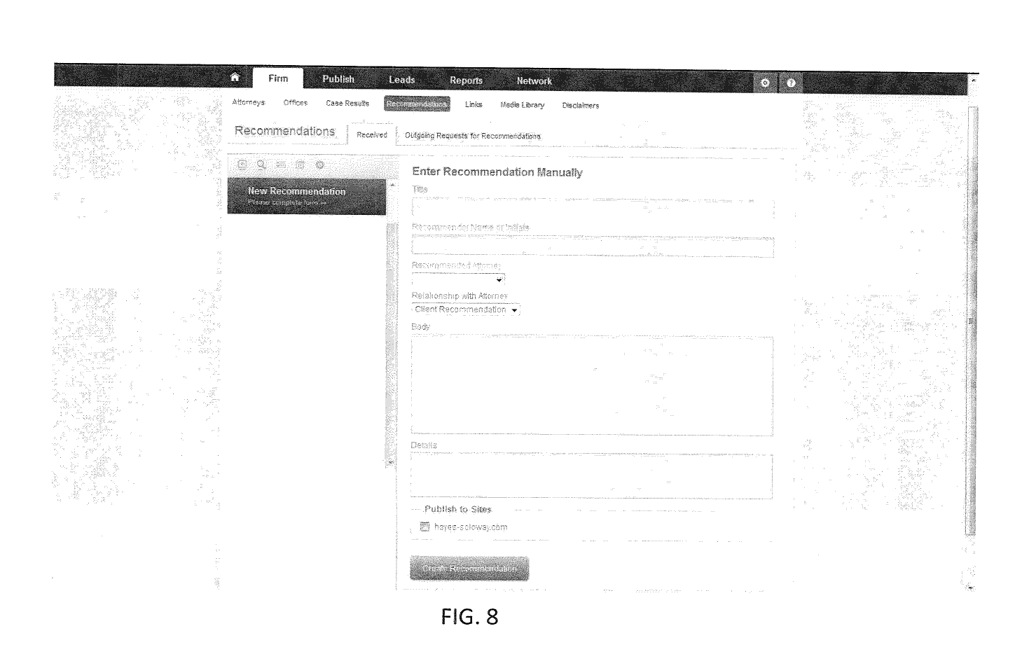

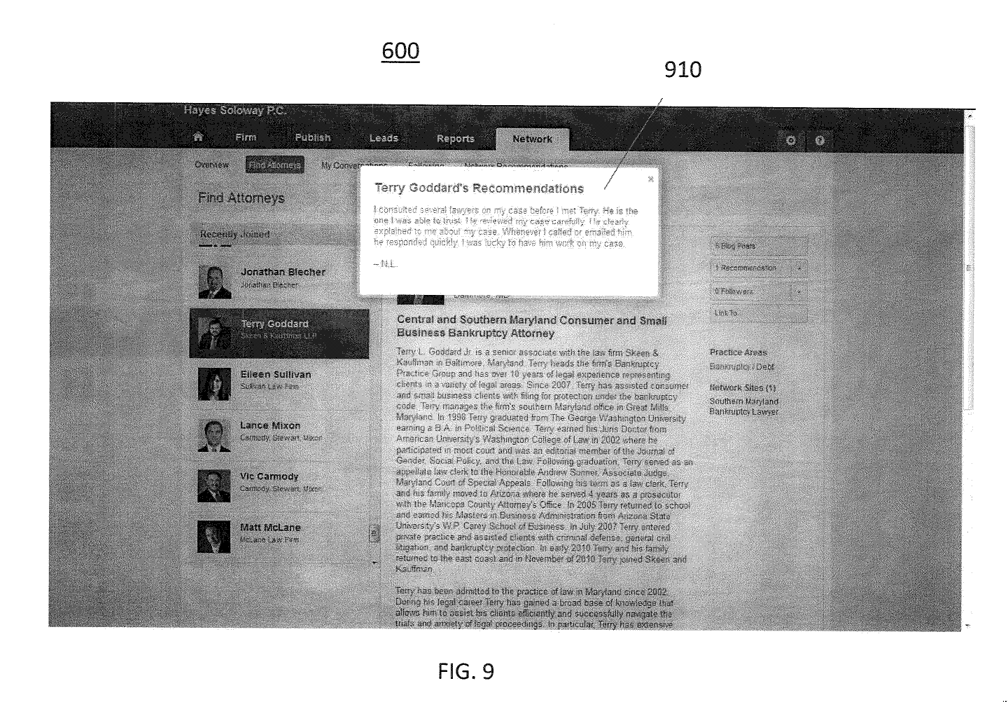

As shown in FIG. 8, a member may manually enter a recommendation himself (e.g., in the case where the recommendation was provided by a client who lacks access to the professional networking application 25). FIG. 9 illustrates a received recommendations window 910 which may be displayed when clicking on the recommendations tab 630. The received recommendations window 910 may display the recommendations received (and/or approved) by the attorney member.

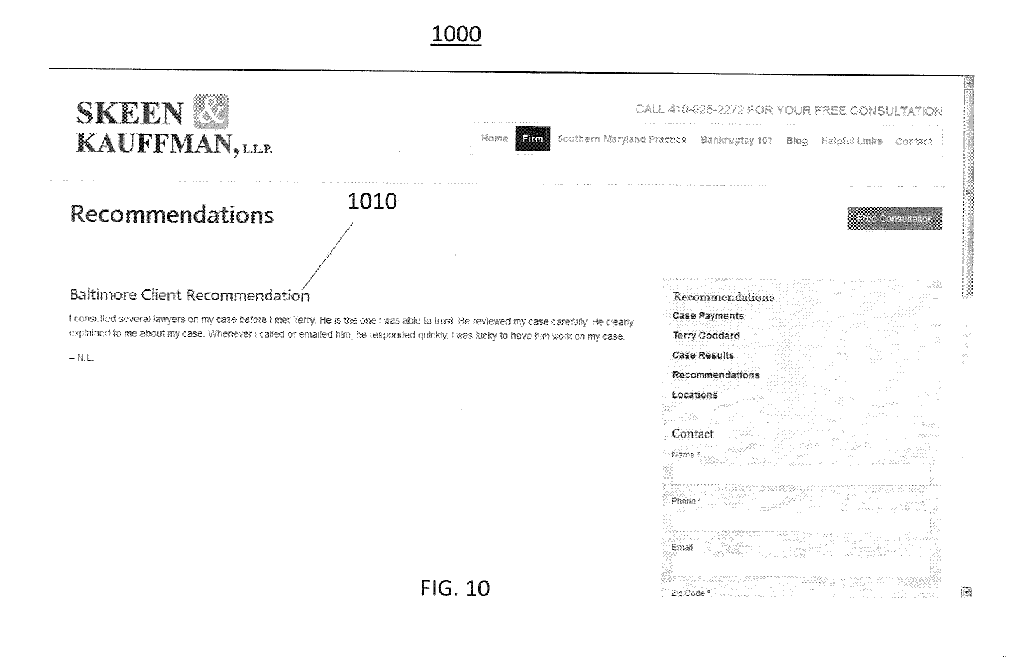

FIG. 10 illustrates a recommendations page 1000 provided by the attorney member's website (i.e., the attorney member's publicly viewable website, having a unique domain name and viewable by a user of a public device 40 without requiring access to the application 25). The recommendations page 1000 may display the recommendations received by other members through the application 25 (via the recommendation module 28) and/or recommendations 1010 received by non-members (e.g., clients) but manually entered by the recommendation-receiving attorney member.

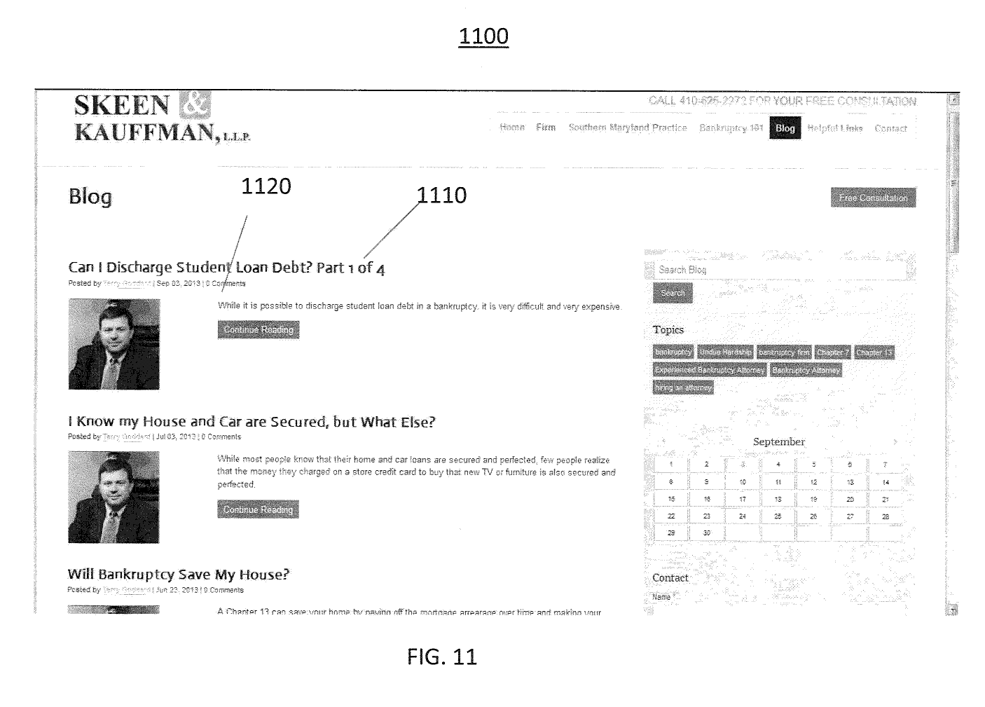

FIG. 11 illustrates a blog page 1100 provided by the attorney member's website. The blog page 1100 displays blog entries 1110 posted by the attorney member using the application 25, and further may include comments 1120, which may have been provided by other members through the professional networking application 25 (via the blog management module 26) and/or by non-members (e.g., directly through the member's website), depending on access-restrictions as set by the attorney member.

As specified herein, the system 10 may include a number of other features to enhance the design, use or functionality of the system 10. These additional features may include functional or aesthetic components within the application 25, such as website components, software based automation or the ability to tailor the system 10 to the preferences of a particular member using the system 10.

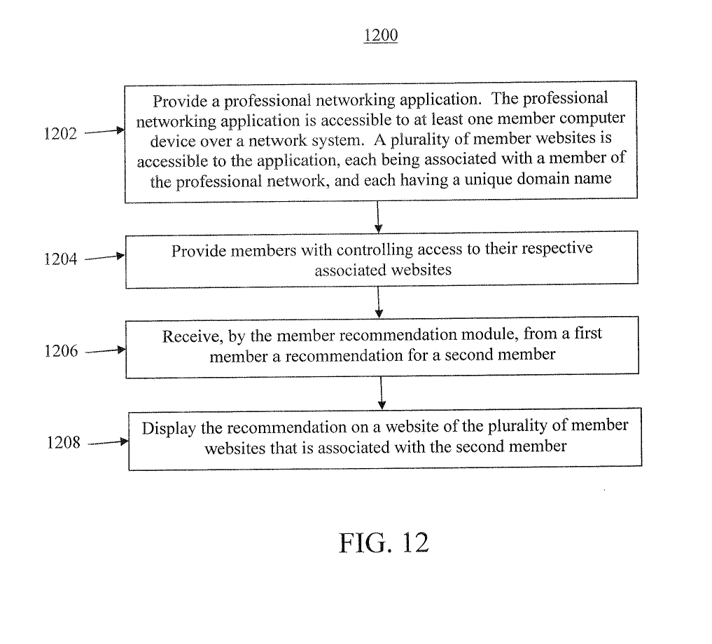

FIG. 12 is a flowchart 1200 illustrating a computer-implemented professional networking process in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently in reverse order, depending on the functionality involved, as would be understood by those reasonably skilled in the art of the present invention.

As shown in block 1202, a professional networking application 25 is provided. The application 25 is hosted at least partially on a server 20 and is electronically accessible over at least one network system 12 to at least one member computer device 30. The professional networking application 25 is configured to access a plurality of member websites, each being associated with a member of the professional network, and the plurality of member websites each have a unique domain name. At block 1204, members are provided with controlling access to their respective associated websites of the plurality of member websites. At block 1206, the member recommendation module, which is accessible to members through the professional networking application, receives from a first member a recommendation for a second member. At block 1208, the recommendation is displayed on a website of the plurality of member websites that is associated with the second member.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. For example, while the disclosure primarily describes the professional network as being composed of lawyers or entities providing legal services, a professional networking system as provided herein may be utilized by entities of any profession in which having a web presence is desirable to, for example, attract new clients and/or build a referral network amongst peers. All such modifications and variations are intended to be included herein within the scope of this disclosure and the present disclosure and protected by the following claims.

What is claimed is:

1. A professional networking system, comprising:
a plurality of member websites, each being associated with a member of the professional networking system, said plurality of member websites each having a unique domain name;
a professional networking application, hosted at least partially on a server and electronically accessible over at least one network system to at least one member computer device, configured to provide members controlling access to their respective associated websites of said plurality of member websites; and
a member recommendation module, accessible to members through the professional networking application, configured to receive from a first member a recommendation for a second member and to facilitate display of said recommendation on a website of said plurality of member websites associated with said second member.

2. The professional networking system of claim 1, wherein the members comprise legal service providing entities.

3. The professional networking system of claim 1, wherein the member recommendation module is further configured to provide said recommendation to said second member and to facilitate display of said recommendation only after receiving approval from said second member.

4. The professional networking system of claim 1, further comprising:
a blog management module, accessible to members through the professional networking application, configured to receive member blog posts and to publish said blog posts on a website of said plurality of member websites associated with the blog posting member.

5. The professional networking system of claim 4, wherein the blog management module is further configured to receive member comments associated with other members' blog posts, and to enable display of said comments on a website associated with the blog posting member.

6. The professional networking system of claim 5, wherein the blog management module is further configured to provide said member comments to the blog posting member and to enable display of said comments only after receiving approval from said blog posting member.

7. A computer-implemented professional networking process, comprising:
providing a professional networking application, hosted at least partially on a server and electronically accessible over at least one network system to at least one member computer device, said professional networking application configured to access a plurality of member websites, each being associated with a member of the professional network, said plurality of member websites each having a unique domain name;
providing members controlling access to their respective associated websites of said plurality of member websites;
receiving, by a member recommendation module accessible to members through the professional networking application, from a first member a recommendation for a second member; and
displaying said recommendation on a website of said plurality of member websites associated with said second member.

8. The professional networking process of claim 7, further comprising:
providing, by the member recommendation module, said recommendation to said second member, wherein said recommendation is displayed only after receiving approval from said second member.

9. The professional networking process of claim 8, further comprising:
receiving, by a blog management module accessible to members through the professional networking application, member blog posts; and
publishing said blog posts on a website of said plurality of member websites associated with the blog posting member.

10. The professional networking process of claim 9, further comprising,
receiving; by the blog management module, member comments associated with other members' blog posts; and
enabling display of said comments on a website associated with the blog posting member.

11. The professional networking process of claim 10, further comprising:
providing said member comments to the blog posting member, wherein said comments are enabled to be displayed only after receiving approval from said blog posting member.

12. A non-transitory computer readable medium containing instructions for providing a professional networking process enabled at least in part on a processor of a computerized device, wherein a plurality of member websites is electronically accessible by the processor, each of said member websites being associated with a member of the professional networking system and each having a unique domain name, and a professional networking application is hosted at least partially on a server and electronically accessible over at least one network system to at least one member computer device, the instructions, which when executed by the processor, performing the steps of:
providing members controlling access to their respective associated websites of said plurality of member websites;
receiving, by a member recommendation module accessible to members through the professional networking application, from a first member a recommendation for a second member; and
displaying said recommendation on a website of said plurality of member websites associated with said second member.
